(19) United States
(12) Patent Application Publication
(10) Pub. No.: US 2018/0324298 A1
(43) Pub. Date: Nov. 8, 2018

(54) NETWORK-CONTROLLED PERSONAL NUMBER HANDLING

(71) Applicant: T-Mobile USA, Inc., Bellevue, WA (US)

(72) Inventors: Muhammad Ejaz Sial, Snoqualmie, WA (US); Shujaur Mufti, Snoqualmie, WA (US); Zeeshan Jahangir, Bellevue, WA (US)

(73) Assignee: T-Mobile USA, Inc.

(21) Appl. No.: 15/863,542

(22) Filed: Jan. 5, 2018

Related U.S. Application Data
(60) Provisional application No. 62/503,229, filed on May 8, 2017.

(51) Int. Cl. H04M 3/436; H04L 29/06; H04M 3/42

(52) U.S. Cl. CPC H04M 3/436; H04L 65/1076; H04L 69/329; H04M 3/42059; H04M 3/42153

(57) ABSTRACT

Systems and methods for network-controlled personal number handling are described. When an incoming call destined for a user device is detected, if the user device is subscribed to network-controlled personal number handling, the incoming call is handled at the network according to the subscription. If an originating number associated with the call has been previously specified by the user, the call may be blocked, forwarded to another number, or sent directly to voice mail. How a call is handled may be determined based on user-specified preferences associated with an originating number of the incoming call.

### CROSS-REFERENCE TO RELATED APPLICATIONS

This application is a non-provisional application of, and claims priority to and the benefit of, U.S. Provisional Patent Application Ser. No. 62/503,229, filed May 8, 2017, and entitled “Phone Number Blocking,” the entirety of which is incorporated herein by reference.

### BACKGROUND

Most mobile phones allow a user to specify specific phone numbers from which the user does not wish to receive calls. Typically, a list of numbers is maintained on the mobile phone, and when the mobile phone receives a call, it compares the originating number to the list, and if the originating number matches a number on the list, the mobile phone terminates the call.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a pictorial diagram of an example communication network configured to implement network-controlled personal number handling.

FIG. 2 is a pictorial diagram of an example user interface configured to receive user preferences associated with a subscription to network-controlled personal number handling.

FIG. 3 is a block diagram of select components of an example user device.

FIG. 4 is a block diagram of select components of an example communication network system configured to implement network-controlled personal number handling.

FIG. 5 is a flow diagram of an example process for providing network-controlled personal number blocking.

FIG. 6 is a flow diagram of an example process for providing network-controlled personal number handling.

FIG. 7 is a flow diagram of an example process for handling a call, at the network, according to pre-specified user preferences.

### DETAILED DESCRIPTION

### Introduction

Systems and methods discussed herein are directed to handling at the network level, calls from user-specified numbers.

In the described example implementations, individual users can subscribe to a personal number handling service offered by the communications network. If the user is subscribed to the personal number handling service, when the network receives a call destined for the user, the network first checks to see if the call is originating from a number previously specified by the user. If it is determined that the call is from a previously specified number, then the call is blocked. In an example implementation, a user may specify particular ways in which a call is to be handled, depending on the originating number of the call. For example, the user may choose to send calls from their mother's number to voicemail and block calls from an ex-spouse.

Handling calls from user-specified numbers at the network level benefits the user in that unwanted calls received at the user device are reduced. Furthermore, use of network resources and device resources is reduced. For example, network bandwidth is not used to deliver calls that are known to be unwanted by the user. On the device, radio resource utilization and battery utilization are improved. For example, in the case of an Internet of Things (IoT) device, if the device is in an idle mode, it will not switch to an active mode to receive a call from an unwanted number. Accordingly, battery life will improve.

### Example Network Environment

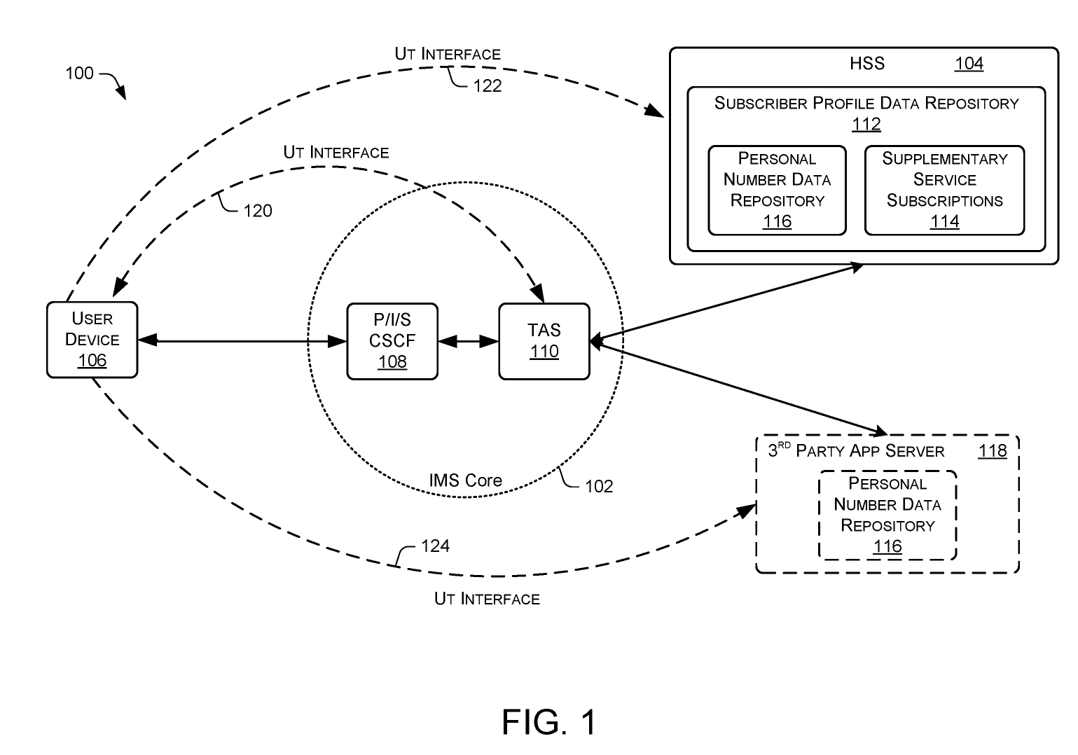

FIG. 1 illustrates an example network environment 100 in which network-controlled personal number handling can be implemented. Example network environment 100 includes IMS (IP multimedia subsystem) core 102, HSS (home subscriber server) 104, and one or more user devices 106. IMS core 102 includes CSCF (call session control function)108, which may include, for example, a proxy CSCF, an interrogating CSCF, and serving CSCF. IMS core 102 also includes TAS (telephony application server) 110. HSS 104 includes subscriber profile data repository 112. Subscriber profile data repository 112 includes supplementary service subscriptions 114, enabling TAS 110 to determine any supplementary services to which the user device is subscribed. If the user is subscribed to personal number handling, a list of user-specified numbers, and optionally call handling preferences for one or more specific numbers, may be stored in personal number data repository 116.

Network environment 100 may also include one or more third-party application servers 118. In an example, a third-party application server 118 may include all or a portion of personal number data repository 116, which stores a list of user-specified phone numbers. Furthermore, other portions of subscriber profile data repository 112 may be maintained on a third-party application server.

When user device 106 connects to the network, TAS 110 authenticates the user device and accesses the subscriber profile data repository 112 to access a user profile associated with the user device.

When IMS core 102 receives a call directed to user device 106, e.g., as a session initiation protocol (SIP) invite, the TAS 110 determines whether or not the user device to which the call is directed is subscribed to personal number handling. If the user device is subscribed to personal number handling, then the TAS compares the originating number associated with the call to a list of user-specified numbers associated with the user profile. For example, TAS searches the personal number data repository 116 for the originating number. If the originating number is found in the personal number data repository 116, the TAS blocks the call, or otherwise handles the call according to user preferences.

For example, personal number data repository may be implemented as a list of user-specified numbers. In such an implementation, when a call is received from a number that is on the list, the call is terminated without being delivered to the user device.

In another example, personal number data repository may be implemented as a list of user-specified numbers and a call handling preference for each number. For example, for each number a user specifies, the user may also select how the call is to be handled including, for example, blocking the call, sending the call directly to voicemail, or forwarding the call to another number. The TAS then handles the call according to the specified preferences for the particular originating number, to, for example, block the call, send the call to voicemail, or forward the call to another number.

In the illustrated example, to subscribe to personal number handling, user device 106 sends a message over the Ut interface 120 using XCAP (XML configuration access protocol) to TAS 110. The message indicates the user's desire to subscribe to personal number handling. The message may also indicate specific numbers and optionally a preference for one or more of the specific numbers. Upon receiving the message via the Ut interface 120, the TAS 110 saves the personal number handling subscription and the user preferences to the subscriber profile data repository 112.

In an alternative example implementation, user device 106 may communicate a request to subscribe to personal number handling and/or one or more numbers (with or without specific handling preferences for each number) over Ut interface 122 directly to HSS 104 to update the subscriber profile data repository 112. In another example, when personal number data repository 116 is maintained by a third-party app server 118, user device 106 may communicate one or more numbers (with or without specific handling preferences for each number) over Ut interface 124 directly to third party app server 118 to update the personal number data repository 116.

User device 106 may be implemented as any of a variety of types of user devices. As one example, user device 106 may be implemented as a mobile phone. As another example, user device 106 may be implemented as an IoT (Internet-of-things) device. User device 106 may be implemented as any suitable mobile computing device configured to communicate over a wireless and/or wireline network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), a networked digital camera, and/or similar mobile devices. Although this description predominantly describes the user device 106 as being “mobile,” (i.e., configured to be carried and moved around) it is to be appreciated that the user device 106 may represent various types of communication devices that are generally stationary as well, such as televisions, desktop computers, game consoles, set top boxes, Internet of Things (IoT) devices, and the like. In this sense, the terms “communication device,” “wireless device,” “wireline device,” “mobile device,” “computing device,” and “user equipment (UE)” may be used interchangeably herein to describe any communication device capable of performing the techniques described herein. Furthermore, the user device 106 may be capable of communicating over wired networks, and/or wirelessly using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), Voice over LTE (VoLTE), 5G, IEEE 802.1x protocols, WiMAX, Wi-Fi, and/or any future IP-based network technology or evolution of an existing IP-based network technology.

### Example User Interface

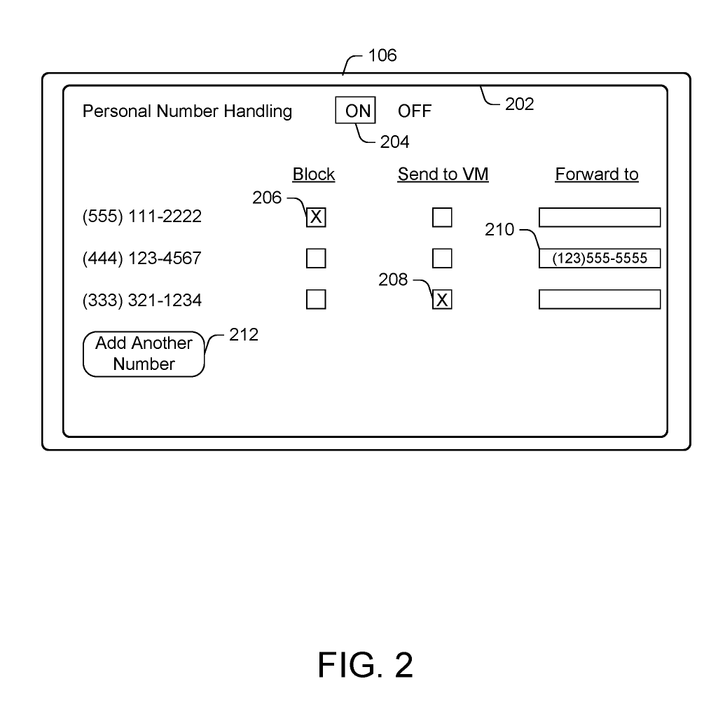

FIG. 2 illustrates an example user interface 202 on user device 106 through which a user can specify personal number handling preferences. For example, when personal number handling is turned on 204, the user can specify a new number. The user can also optionally specify how calls from that number are to be handled. In an example implementation, the default is for the number to be blocked, and options are given to have calls from that number sent to voicemail or forwarded to another number.

In the example illustrated in FIG. 2, a user has specified that calls from (555) 111-2222 are to be blocked 206; calls from (444) 123-4567 are to be forwarded 210 to (123) 555-5555; and calls from (333) 321-1234 are to be sent directly to voicemail 208. In the illustrated example selecting the “Add Another Number” button 212 will allow the user to enter another number and call handling preferences for that number.

### Example User Device

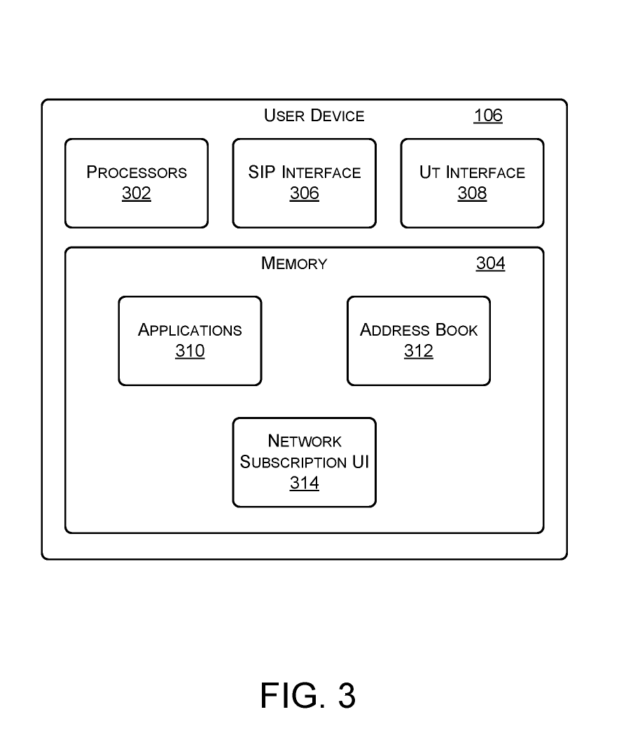

FIG. 3 illustrates select components of an example user device 106. Example user device 106 includes one or more processors 302, memory 304 communicatively coupled to the one or more processors 302, SIP interface 306, and Ut interface 308. Memory 304 may include, for example, any number of applications 310, an address book 312, and a network subscription user interface 314.

SIP interface 306 enables user device 106 to communicate with the network via the session initiation protocol (SIP). Ut interface 308 enables user device 106 to communicate directly to the TAS 110 or a third-party application server 118 via XCAP. Enhancements to the Ut interface will support the additional Ut interface communications described herein.

Applications 310 may include any number of applications for execution by the processor 302. Examples may include games, Internet browsers, social media applications, music applications, and so on. Address book 312 is configured to store names, phone numbers, addresses, etc. associated with any number of contacts.

Network subscription user interface 314 provides a graphical user interface that allows a user of user device 106 to subscribe to or unsubscribe from any number of supplementary services. Communication networks may provide any number of supplementary services, examples of which may include, call forwarding, barring all incoming calls, barring all outgoing calls, call hold, call waiting, etc. Such supplementary services also include network-controlled personal number handling as described herein. The example user interface shown in FIG. 2 is an example of a portion of an example network subscription user interface 314.

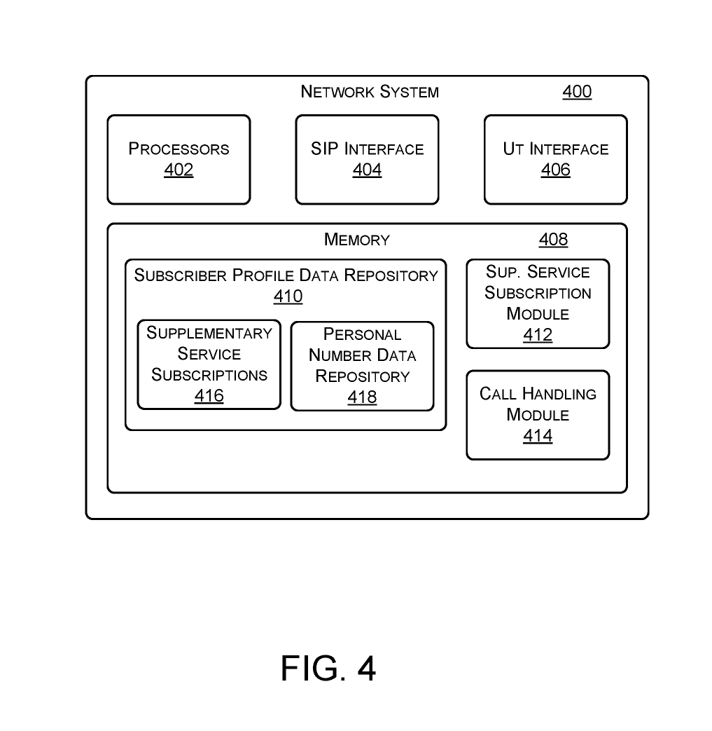

FIG. 4 illustrates select components of a communication network system 400 configured to implement network-controlled personal number handling as described herein. Example network system 400 includes one or more processors 402, SIP interface 404, Ut interface 406, and memory 408 communicatively coupled to the one or more processors 402. Memory 408 may include, for example, subscriber profile data repository 410, supplementary service subscription module 412, and call handling module 414. Subscriber profile data repository 410 includes supplementary service subscriptions 416 and personal number data repository 418. The example components shown in FIG. 4 may be implemented on a single server or may be distributed across multiple servers that are communicatively coupled one to another. Furthermore, individual components may be implemented on a third-party application server.

SIP interface 404 enables network system 400 to communicate with other system components (e.g., user devices) via the session initiation protocol (SIP). Ut interface 406 enables network system 400 to communicate with other system components (e.g., user devices) via XCAP.

Subscriber profile data repository 410 maintains user profile data for user devices associated with the network system 400. User profile data may include, for example, user name, phone number, user device ID, billing data, and so on. In addition, subscriber profile data repository includes supplementary service subscriptions 416, which maintains a list of supplementary services to which a user device is subscribed and personal number data repository 418, which maintains user-specified numbers and, optionally, call handling preferences for those numbers.

Supplementary service subscription module 412 is configured to manage subscriber subscriptions. For example, supplementary service subscription module 412 receives requests from user devices to add or remove supplementary service subscriptions. In response to those requests, supplementary service subscription module 412 updates the supplementary service subscriptions 416 and the personal number data repository 418.

Call handling module 414 is configured to handle an incoming call according to user subscriptions and user preferences. For example, when an incoming call is received by the network system 400, call handling module 414 determines whether or not the user device to which the call is destined is subscribed to personal number handling. If the user device is subscribed to personal number handling, the call may be blocked, or otherwise handled according to user-specified preferences for that number.

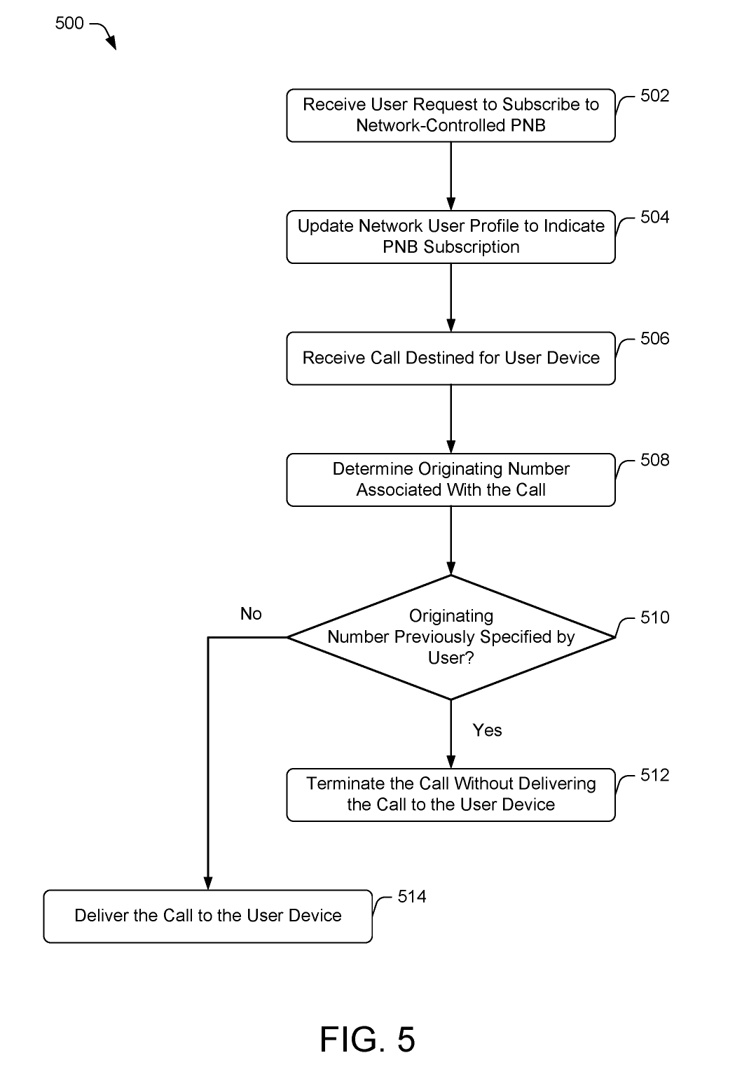

FIG. 5 is a flow chart of an example process 500 for providing network-controlled personal number blocking.

At block 502, a request to subscribe to network-controlled personal number blocking (PNB) is received. For example TAS 110 receives an XCAP request from user device 106, requesting to subscribe the user device 106 to network-controlled personal number blocking.

At block 504, a network user profile is updated to indicate the requested PNB subscription. For example, TAS 110 communicates with HSS 104 to add an entry to supplementary service subscriptions 114 indicating that user device 106 is subscribed to the requested network-controlled personal number blocking.

At block 506, a call destined for the user device is received. For example, IMS core 102 receives a call for which user device 106 is the intended recipient.

At block 508, an originating number associated with the call is determined. For example, TAS 110 extracts an originating number from a SIP header of an incoming SIP invite message that defines the call.

At block 510, it is determined whether or not the originating number has been previously specified by the user. For example, TAS searches the personal number data repository 116 for the originating number associated with the received call.

If the originating number is located in the personal number data repository (the “Yes” branch from block 510), then at block 512, TAS 110 terminates the call without delivering the call the user device 106.

On the other hand, if the originating number is not found in the personal number data repository (the “No” branch from block 510), then at block 514, the call is delivered, through the S-CSCF 108, to the user device 106.

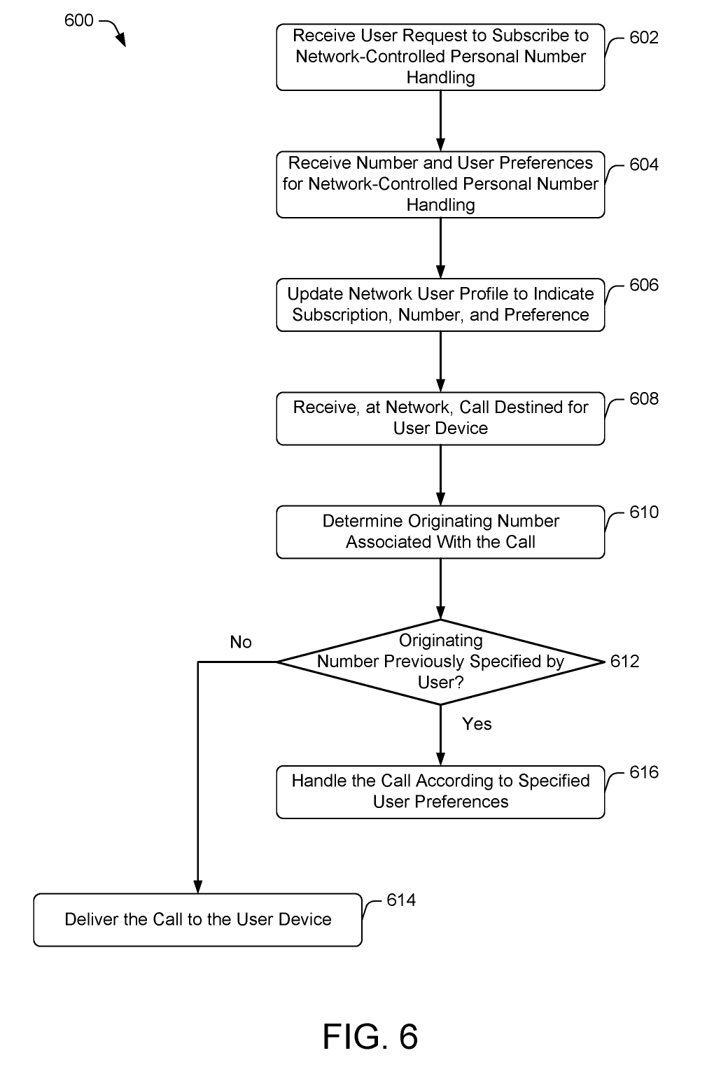

FIG. 6 is a flow chart of an example process 600 for providing network-controlled personal number handling.

At block 602, a request to subscribe to network-controlled personal number handling is received. For example, supplementary service subscription module 412 receives, from a user device, an XCAP request to subscribe to network-controlled personal number handling.

At block 604, a number and a user preference for that number are received. For example, the received XCAP request may include a particular number and a preference for handling calls from that number.

At block 606, a network user profile is updated to indicate the subscription, a user-specified number, and a call handling preference. For example, supplementary service subscription module 412 communicates with subscriber profile data repository 410 to add personal number handling to the supplementary service subscriptions 416 for the user associated with the received request. If a number and, optionally, a user preference for calls from that number are specified, subscriber profile data repository 410 also adds the number and call handling preference to personal number data repository 418.

At block 608, a call destined for the user device is received at the network. For example, an incoming call is received via the SIP interface 404.

At block 610, an originating number associated with the call is determined. For example, call handling module 414 extracts an originating number from a SIP header of an incoming SIP invite message that defines the call.

At block 612, it is determined whether or not the originating number associated with the call has been previously specified by the user for network-controlled personal number handling.

If the originating number has not been previously specified by the user for network-controlled personal number handling (the “No” branch from block 612), then at block 614, the call is delivered to the user device.

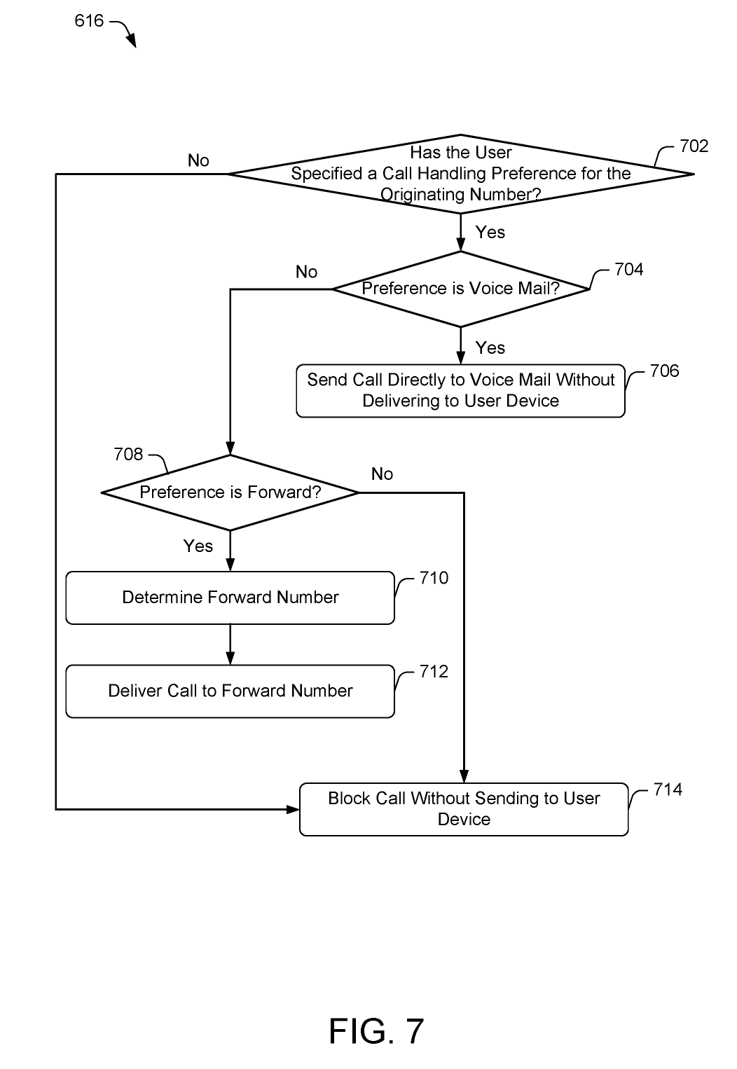

On the other hand, if the originating number has been previously specified by the user for network-controlled personal number handling (the “Yes” branch from block 612), then at block 616, the call is handled at the network according to the specified user preferences associated with the originating number. For example, call handling module 414 requests data from personal number data repository 418 to determine user preferences for the originating number. Specific examples are described in more detail below with regard to FIG. 7.

FIG. 7 is a flow chart of an example process 616 for handling a call, at the network, according to pre-specified user preferences.

At block 702, a determination is made as to whether or not a user has specified a preference for handling a call from the originating number associated with a call. For example, call handling module 414 accesses personal number data repository 418 to determine whether or not the originating number has been specified by the user, and if so, what call handling preference is associated with the number.

If it is determined that the user has not specified a preference for handling a call from the originating number (the “No” branch from block 702), then default processing continues as describe below with reference to block 714.

On the other hand, if it is determined that the user has specified a preference for handing a call from the originating number (the “Yes” branch from block 702), then at block 704, a determination is made as to whether or not the user preference is to send the call to voice mail. For example, call handling module 414 determines whether data in the personal number data repository 418 indicates that the user has specified that calls from the originating number are to be sent to voice mail.

If it is determined that the user preference is to send the call to voice mail (the “Yes” branch from block 704), then at block 706, the call is sent directly to voice mail without delivering the call to the user device.

On the other hand, if it is determined that the user preference is not to send the call to voice mail (the “No” branch from block 704), then at block 708, a determination is made as to whether or not the user preference is to forward the call to another number. For example, call handling module 414 determines whether data in the personal number data repository 418 indicates that the user has specified that calls from the originating number are to be forwarded to another number.

If it is determined that the user preference is to forward the call to another number (the “Yes” branch from block 708), then at block 710, the number to which the call is to be forwarded is determined. For example, call handling module 414 access data in personal number data repository to determine the number to which calls from the originating number are to be forwarded.

At block 712, the call is delivered to the forward number. For example, call handling module 414 forwards the call to the number determined at block 710.

On the other hand, if it is determined that the user preference is not to forward the call (the “No” branch from block 708), then at block 714, a default action is taken of terminating the call without delivering the call to the user device. For example, call handling module 414 terminates the call.

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Memory 304 and memory 408 are examples of computer storage media.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1-7. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method implemented at a communication network, the method comprising:
receiving, at the communication network, a call directed to a particular user device;
determining an originating number associated with call;
determining that calls from the originating number to the particular user device are to be blocked; and
preventing the call from being delivered to the user device.

2. A method as recited in claim 1, further comprising receiving a request to subscribe the user device to network-controlled personal number blocking, wherein:
determining that calls from the originating number to the particular user device are to be blocked is based, at least in part, on the request to subscribe the user device to network-controlled personal number blocking.

3. A method as recited in claim 2, wherein receiving the request comprises receiving the request as an extensible markup language configuration access protocol (XCAP) request via a Ut interface.

4. A method as recited in claim 2, further comprising:
in response to receiving the request to subscribe the user device to network-controlled personal number blocking, updating a network user profile to indicate that the user device is subscribed to network-controlled personal number blocking.

5. A method implemented at a communication network, the method comprising:
receiving, at the communication network, a call directed to a particular user device;
determining an originating number associated with the call;
determining a user-specified call handling preference associated with the originating number; and
the communication network handling the call according to the user-specified call handling preference.

6. A method as recited in claim 5, wherein handling the call according to the user-specified call handling preference comprises terminating the call without delivering the call to the user device.

7. A method as recited in claim 5, wherein handling the call according to the user-specified call handling preference comprises sending the call directly to voice mail without delivering the call to the user device.

8. A method as recited in claim 5, wherein handling the call according to the user-specified call handling preference comprises forwarding the call to another number.

9. A method as recited in claim 5, further comprising:
receiving, from a user device, a request to subscribe to network-controlled personal number blocking;
receiving from the user device, a number from which calls are to be handled by the network;
receiving from the user device, a call handling preference associated with the number.

10. A communication network comprising:
one or more processors;
memory, communicatively coupled to the one or more processors;
a call handling module stored in the memory and executed on the processor, the call handling module configured to:
determine an originating number associated with an incoming call;
based, at least in part, on the originating number, handle the incoming call according to one or more user-specified preferences.

11. A communication network as recited in claim 10, wherein the user-specified preferences indicate that the call is to be terminated without being delivered to the user device.

12. A communication network as recited in claim 10, wherein the user-specified preferences indicate that the call is to be forwarded to another number instead of being delivered to the user device.

13. A communication network as recited in claim 10, wherein the user-specified preferences indicate that the call is to be sent directly to voice mail without being delivered to the user device.

14. A communication network as recited in claim 10, further comprising:
a subscriber profile data repository, the subscriber profile data repository including:
supplementary service subscriptions that indicate, for a particular user device, any number of supplementary service subscriptions to which the user device is subscribed,
wherein:
the user-specified preferences include an indication that a user device to which the incoming call is destined is subscribed to network-controlled personal number handling.

15. A communication network as recited in claim 14, wherein:
the subscriber profile data repository further includes call handling preferences that specify, for a particular phone number, a user preference for how the network is to handle an incoming call from the particular phone number.

16. A communication network as recited in claim 10, further comprising:
a Ut interface for receiving an XCAP request from a user device, the XCAP request indicating that the user device is to requesting to subscribe to network-controlled personal number handling.

17. A communication network as recited in claim 16, wherein the XCAP request further indicates an originating number from which calls are to be handled at the network.

18. A communication network as recited in claim 16, wherein the XCAP request further indicates, for one or more originating numbers, a user preference for how incoming calls from the originating numbers are to be handled by the communication network.

19. A communication network as recited in claim 10, further comprising a personal number data repository configured to store a list of user-specified numbers, wherein incoming calls from the user-specified numbers are to be handled at the network.

20. A communication network as recited in claim 19, wherein the personal number data repository is configured to receive, from a user device, via a Ut interface, an XCAP request to add a number to the robocall number data repository.
